(19) United States
(12) Patent Application Publication
(10) Pub. No.: US 2016/0055936 A1
(43) Pub. Date: Feb. 25, 2016

(54) BRAIDED STRUCTURE WITH ELECTRICALLY CONDUCTIVE TOWS

(71) Applicant: A&P Technology, Inc., Cincinnati, OH (US)

(72) Inventors: Andrew A. HEAD, Cincinnati, OH (US); Michael S. BRALEY, Cincinnati, OH (US); Victor M. IVERS, Amelia, OH (US)

(21) Appl. No.: 14/831,985

(22) Filed: Aug. 21, 2015

Related U.S. Application Data
(60) Provisional application No. 62/040,574, filed on Aug. 22, 2014.
(60) Provisional application No. 62/083,396, filed on Nov. 24, 2014.

(51) Int. Cl. H01B 5/12; D04C 1/12; D04C 1/02

(52) U.S. Cl. CPC H01B 5/12; D04C 1/02; D04C 1/12

(57) ABSTRACT

Electrically conductive braided structures having resistivity are disclosed. In an embodiment a structure comprises a plurality of nonconductive bias tows formed of fibers of a nonconductive material and at least one conductive tow formed of fibers including at least one conductive material. The plurality of nonconductive bias tows and the at least one conductive tow are arranged to form a braided structure.

### CROSS-REFERENCE TO RELATED APPLICATIONS

This patent application claims priority to and the benefit of pending provisional patent application 62/040,574 filed on Aug. 22, 2014, as well as pending provisional patent application 62/083,396 filed on Nov. 24, 2014, both of which are incorporated by reference herein in their entirety.

### TECHNICAL FIELD

The present subject matter relates to braided structures comprised of tows having different compositions.

### BACKGROUND

There are a variety of assemblies that can utilize predetermined, uniform conductivity for electrical currents. For example, vehicle ignition wires and power distribution wires in vehicles such as semi-trucks utilize such parts. The conductivity for such arrangements can be expressed in terms of resistivity (the inverse of conductivity) in linear units such as ohms per foot.

To select appropriate resistivity, which can be different than those associated with metal conductors, in-line resistors can be employed. These reduce conductivity by adding resistance over a portion of the conductive path. However, such resistors add weight, accumulate heat in the resistor element, and manufacturing complexity in conjunction with the conductor inasmuch as resistor elements are typically molded-in. Moreover, the conductive path must be lightweight and strong, and the resistor element adds a non-uniform portion which can be a point of failure.

### SUMMARY

In an embodiment a structure comprises a plurality of nonconductive bias tows formed of fibers of a nonconductive material and at least one conductive tow formed of fibers including at least one conductive material. The plurality of nonconductive bias tows and the at least one conductive tow are arranged to form a braided structure.

In an embodiment a structure comprises a braided sleeve comprising at least a plurality of bias tows, the bias tows are formed of a non-conductive material and at least one axial tow, the at least one axial tow is formed of a conductive material. The braided sleeve encloses the at least one axial tow.

In an embodiment, a method comprises providing a plurality of non-conductive tows, providing at least one conductive tow, braiding the non-conductive tows and at least one conductive tow to form a unit cell pattern, the non-conductive tows comprise at least bias tows; repeatedly braiding the unit cell pattern to produce a braided structure.

### BRIEF DESCRIPTION OF DRAWINGS

FIG. 1 illustrates an example embodiment of a portion of a braided structure including bias tows.

FIG. 2 illustrates an example of a portion of a braided structure including bias and axial tows.

FIG. 3 illustrates a stretch-break technique used in conjunction with tows disclosed herein.

FIG. 4 illustrates an example of a portion of braided structure including a sleeve over one or more axial tows.

FIG. 5 illustrates at portion of a braided structure wound around a core.

FIG. 6 illustrates a flow diagram of an example methodology for manufacturing a braided structure disclosed herein.

### DETAILED DESCRIPTION

Braided structures with electrically conductive tows are disclosed to provide a lightweight, stable structure with uniform linear resistivity thereby providing a single component with the desired properties immediately suitable in manufacture or assembly of the final product.

As used herein, a “braided structure” is a product comprised of three or more strands of material (tows) such that each tow is joined with other tows in a repeating intertwined pattern. Two-dimensional braided materials are those wherein the repeating pattern is largely characterized by two or more principal directions in a plane, typically the longitudinal direction of the braided structure, commonly called the axial direction, and one or more oblique directions, commonly called bias directions, each at a predetermined angle to the longitudinal direction. Three-dimensional braided structures are those wherein additional principal directions, generally mutually perpendicular to the longitudinal and oblique directions, are required to completely define the structure and the patterns thereof. For simplicity of description these additional directions are generically referred to as radial directions, whether the structure is generally tubular in form, laid out as a flattened tubular form or in a fabric, or generally planar, form.

Two-dimensional braided structures may be manufactured as generally cylindrical materials, commonly called sleeves, with the axial direction corresponding to the longitudinal axis of the cylinder and the bias directions oblique to the longitudinal axis. Braided structures manufactured in cylindrical form may then be laid-flat to form a two-dimensional fabric comprised of two layers joined along the longitudinal edges. The edges may be removed to form two separate and distinct layers. One edge may be removed and the cylindrical structure laid-flat to form a singly-slit single layer structure. Two edges may be removed to form a double-slit two layer structure. Two-dimensional braided structures may further be manufactured in a single layer flat form, commonly called a tape.

The terms “strand”, “tow”, “yarn”, “yarn bundle”, “fiber” and “fiber bundle” are generally meant to describe a primary intertwined component of the braided structure, laid in each of the principal directions. The tow itself may be comprised of multiple components (e.g., individual filaments) that run together in a principal direction. A tow can comprise monofilament arrangements, multiple filament arrangements or be comprised of staple or spun material. Tow material can have a variety of cross-sectional shapes, including but not limited to, circular, ellipsoidal, triangular and flat tape shapes, as well as other variants thereof. Tow material may be subject to intermediate or pre-processing prior to braiding operations. Examples of intermediate or pre-processing may include, but are not limited to, twisting, braiding small numbers of filaments into braided tow materials, pre-impregnation with resins and specialty coating to facilitate braiding and/or subsequent processing. A tow can comprise any combination of these materials and material forms. Any one tow may comprise one or more filament or staple materials. As non-limiting examples, a tow may be comprised of carbon materials, basalt, glass materials, thermoplastic polymeric materials, thermoset polymeric materials, a combination of carbon and polymeric materials or a combination of polymeric and glass materials, or some combination thereof. Tows that lay in one of the bias directions of the fabric are commonly called bias tows. Tows that lay in the axial direction of the fabric are commonly called axial tows.

As used herein, “electrically conductive tow” refers to a tow as defined above that is comprised of at least one electrically conductive material. The electrically conductive material may be carbon fiber, metal, electroactive polymer, or an electrically non-conductive material enveloped by an electroactive polymer or other thin film, electrically conductive material.

As used herein, biaxial braid describes braided structures comprised of bias tows. Triaxial braid is comprised of bias and axial tows. Hybrid braided structure are contiguous materials comprised of adjacent regions of biaxial and triaxial braid.

Braided structures for use in structural composite components can be comprised of large cross-section carbon fibers such as 7K or 12K fibers, where the designation generally refers to the numbers of filaments amalgamated in the fiber. For instance, 12K fibers have 12,000 filaments amalgamated in the fiber. For braided structures for the example applications low cross-section carbon fibers such as 1K and 1/2K fibers may be used to increase the resistivity of the tow.

Braided conductors provide uniform resistivity through their dimensions and accordingly improve upon integration of smaller resistor elements placed within conductive paths. The uniformity of the braided structures of the embodiments disclosed is in part due to the inherent regularity within braided structures. The inherent regularity can be explained using the structure's “unit cell.” Braided structures can be based on a unit cell which can repeat throughout the structure. The unit cell can be repeated in at least two principle directions to produce the resultant braided structure from repetitions of the unit cell pattern. The unit cell is determined by a number of manufacturing parameters including, but not limited to, braider size, fiber size, fiber tension, former plate geometry, and haul-off speed. All of these factors, and more, may be varied to yield a predetermined linear resistivity. By way of analogy, a unit cell can be compared to a tile; the tile is the base unit of a tiled surface, and while groups of tiles may form symmetrical or repeatable structures, the individual tile is the fundamental element therein. While structures may contain two or more distinct unit cell types in embodiments, the same unit cell is assumed in references to a unit cell unless otherwise indicated.

Unit cell geometry can be analyzed and predetermined to produce a resultant braided structure having a nominal linear resistivity. For newly designed unit cells, braided structures can be tested through measurement of their resistivity and comparison to a desired nominal resistivity value. If the resistivity is not within an appropriate tolerance of the desired nominal value, the unit cell can be redesigned by varying the manufacturing parameters or other factors. The manufacturing process can be accordingly verified, and further development and testing can occur iteratively until the desired nominal resistivity is produced in a braided structure of a particular unit cell design.

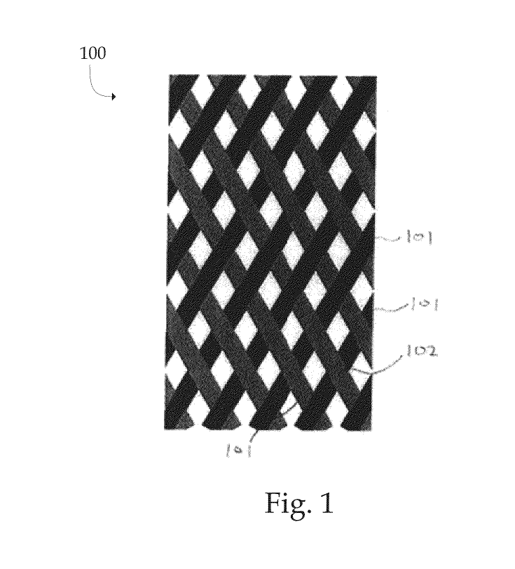

Turning to the drawings, an example embodiment of a portion of a braided structure 100 disclosed herein is shown in FIG. 1 and is comprised of non-conductive bias tows 101 and at least one bias tow 102 being an electrically conductive tow. In embodiments, non-conductive bias tows 101 may be comprised of, e.g., glass fibers or other electrically non-conductive material.

In braided structures of generally cylindrical form the bias tows follow a helical path through the structure. The helical path increases the linear length of tow material relative to the linear length of the braided structure. In this way a conductive path can be made longer than the linear distance ultimately occupied by the braided structure, creating more design options to achieve a particular linear resistivity.

The resistivity of said braided structures can be modified to fit the requirements of a specific application by, e.g., altering the amount of electrically conductive material, altering the cross-sectional shape of the electrically conductive tow, or varying the bias angle of the braided structure.

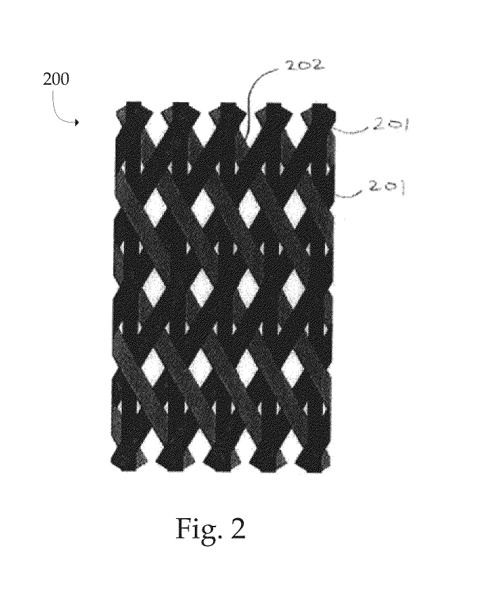

An alternate embodiment of a portion of a braided structure 200 disclosed herein is shown in FIG. 2. Braided structure 200 is comprised of non-conductive bias tows 201 and at least one conductive axial tow 202. In an embodiment, non-conductive bias tows 201 are comprised of glass fibers 201 or other electrically non-conductive material.

The resistivity of braided structure 200 can be altered to fit the requirements of a specific application by altering the amount of electrically conductive fiber or altering the cross-sectional shape of the electrically conductive fiber.

Resistivity can be increased using a biaxial braided structure with at least one conductive bias tow and the remaining bias tows comprised of non-conductive materials such as glass. Said example may include axial tows of non-conductive material. In such embodiments a braided structure may be manufactured in a sleeve form on conventional braiding machines and then deployed to envelope a core of non-conductive material or manufactured as an overbraid over a core of non-conductive material.

Sleeves of this type have generally circular cross sections. The bias tows may include hot melt materials. The braided structure may be shaped into non-circular cross sections and then the hot melt materials melted or semi-melted by application of heat to cause the braided structure to retain the non-circular cross section.

Alternately, axial tows may be comprised of hot melt materials to facilitate retention of the shape of non-circular cross sections.

In additional high resistivity embodiments, specially-formed or processed tows can be employed. In one high resistivity an embodiment, the electrically conductive tow is a “stretch-broken tow” comprised of what are referred to as “stretch-broken yarns”.

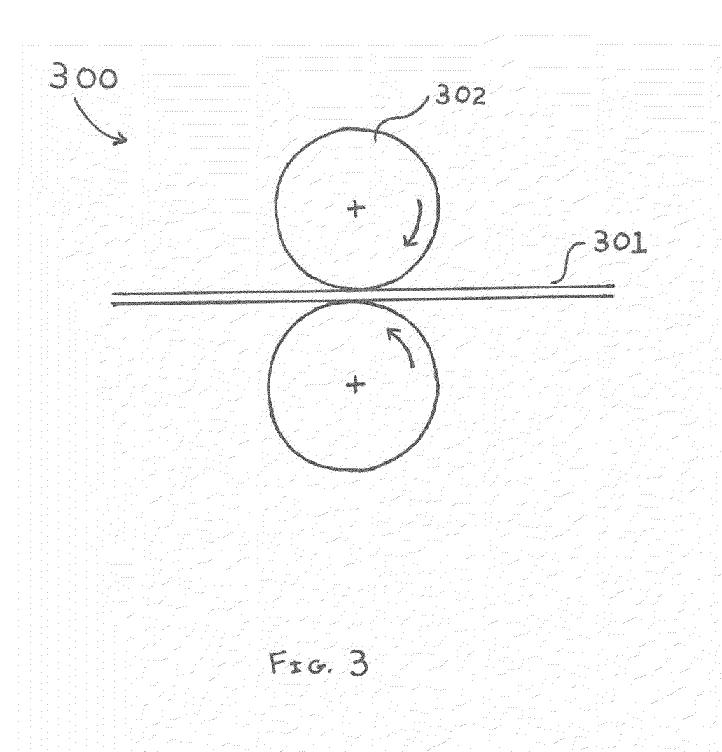

Stretch-broken tows are manufactured from conventional conductive tow materials such as carbon fiber. FIG. 3 provides an illustration of an electrically-conductive fiber 301 being fed into a set of opposing rollers 302 at a first speed and pulling them from rollers 302 at a second, generally higher speed. For example, said fibers have been manufactured by feeding carbon fiber into a set of opposing rollers at 1 foot per minute and pulling them from the rollers at 2 feet per minute. The relative speed and normal force applied to the rollers at the example relative speeds results in a contiguous fiber wherein individual filaments have been uniformly stretched and broken into average lengths of 1/2 to 1 inch.

Stretch-broken tows increase the resistivity of the tow since the breaks in the filaments form a geometric discontinuity which impedes the flow of electricity. For example, electricity must make a transverse jump to adjacent filaments near each discontinuity.

In an alternate embodiment, an electrically conductive tow material is twisted thereby increasing the linear length of the electronically conductive tow relative to the linear length of the braided structure.

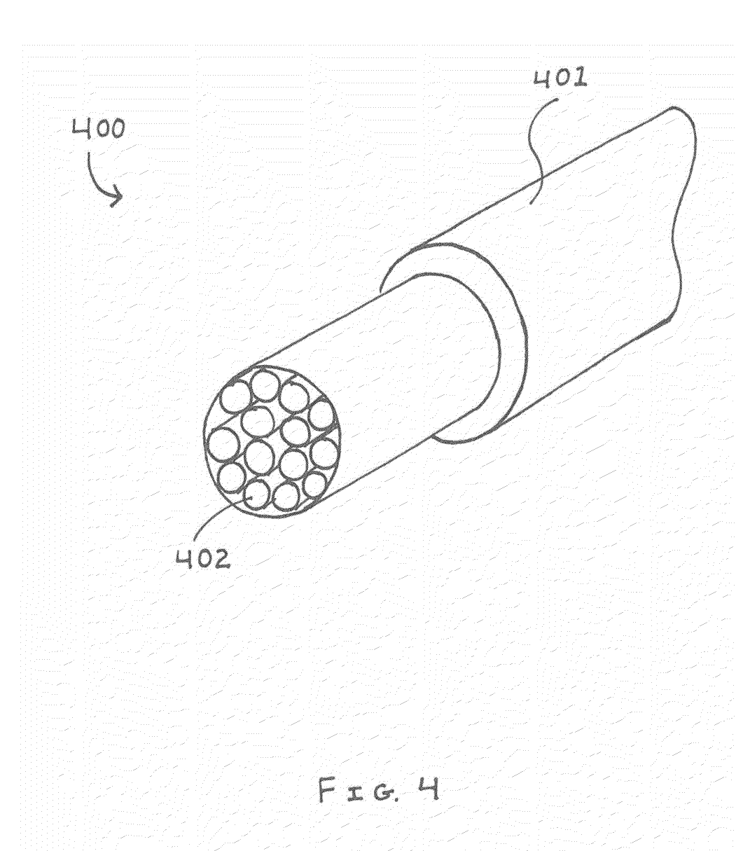

For lower resistivity applications, a non-conductive sleeve may be provided around conductive axial tows. As shown in FIG. 4, sleeve 401 comprised of non-electrically conductive bias tows may envelope axial tows of conductive fibers 402. With respect to such embodiments, braided structures for the example applications have been manufactured with said structure and a resultant linear resistivity of 1 ohm per foot. Other possible linear resistivities can vary between 0 ohms per foot and 500 ohms per foot (e.g., 180 ohms per foot, 500 ohms per foot). In embodiments, the resistivity is greater than 500 ohms per foot.

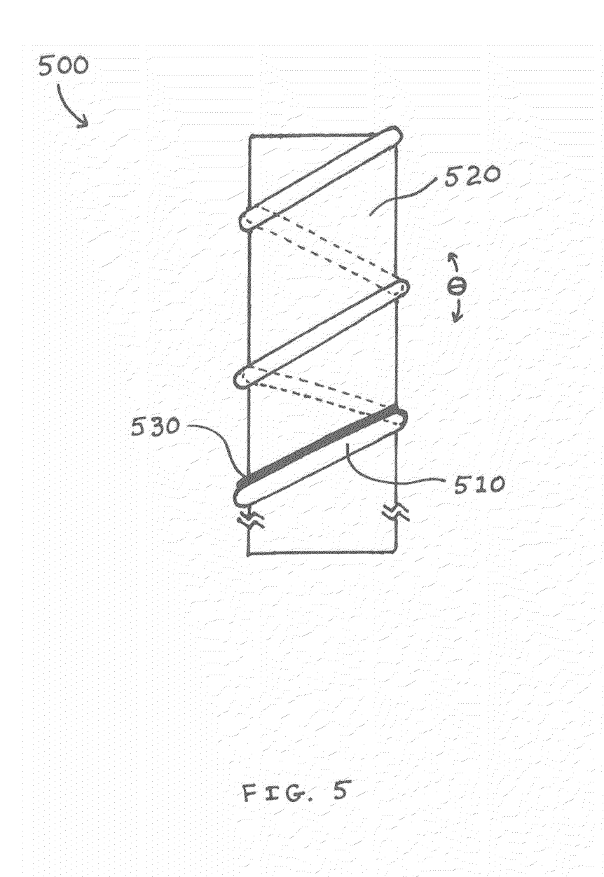

As shown in FIG. 5, in an alternate embodiment, a conductive structure 500 with electrically conductive tows, at least one electrically conductive tow 510 helically wound around a non-conductive core 520 is provided. Electrically conductive tow 520 is not intertwined in a braided structure but wrapped around a core 520. Wrapping occurs with a uniform lead angle θ predetermined to yield a specific linear resistivity per unit length of said braided structure. In an embodiment, at least one electrically conductive tow 510 has been subjected to a stretch-breaking process prior to being helically wound around non-conductive core 520.

In an embodiment of structure 500, multiple electrically conductive tows can be wound around non-conductive core 520. In such embodiments, the different electrically conductive tows can have the same or different lead angles, and can be arranged to avoid overlapping where multiple conductive paths are defined, or can be shielded (e.g., with a nonconductive braided sleeve, with a non-braided cover, with a coating) from electrical coupling.

The uniformity of lead angle 0 can be preserved by applying glue 530 to core 520 or applying glue to electrically conductive tow 510 as it is wound onto core 520. Glue 530 or other adhesives can be applied locally according to positioning of electrically conductive tow 510 or about the entirety of core 520.

Alternately, the core material may be comprised of a thermoplastic material. As electrically conductive tow 510 is wound around core 520, heat is applied to melt the thermoplastic material and upon cooling the thermoplastic material holds the wound electrically conductive tow 510 in place on core 520. Alternately, a thermoplastic material in fiber form may be co-wound with the electrically conductive tow 510 onto the core 520.

In a further alternate form the electrically conductive tow 510 may be pre-impregnated with a fixative material prior to the winding operation and affixed to the core upon application of heat and cool-down or the addition of a catalytic material as electrically conductive tow 510 is wound onto core 520. The uniformity of the lead angle may be further preserved post-manufacture by application of a protective covering after wrapping.

In an alternate embodiment of the present invention a textile structure with electrically conductive tows may be comprised of multiple layers of structure, each layer of which may be comprised of the structure and alternate embodiments described herein. One application of said alternate embodiment is a single textile structure with multiple conductive paths each of predetermined linear resistivity.

In all embodiments herein and as supported by the definition of “tow” herein, non-conductive fibers may be laid into a tow adjacent to conductive fibers to alter the tensile strength of the conductive tow relative to the other tows in the braided structure.

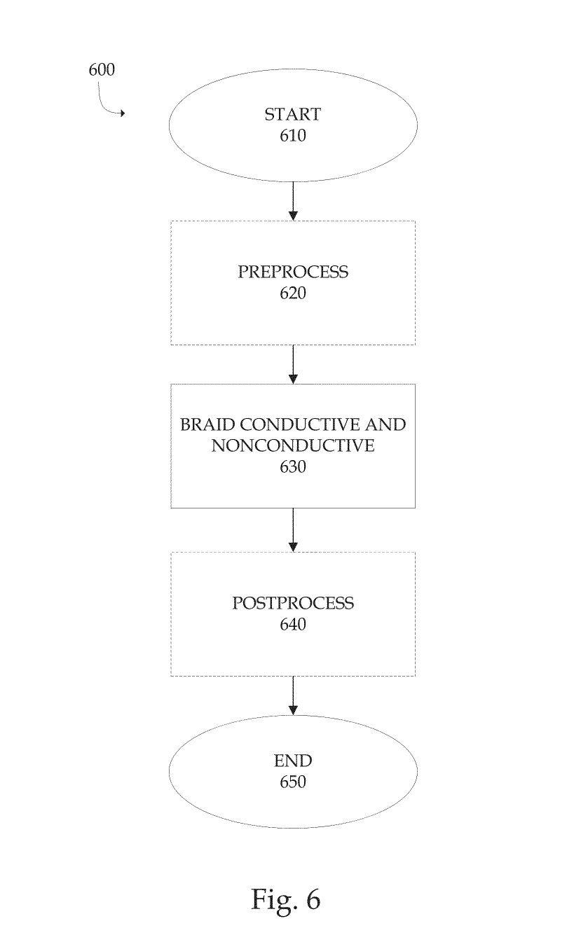

FIG. 6 illustrates a methodology 600 for manufacturing a conductive braided structure as disclosed herein. Methodology 600 begins at 610 and proceeds to 620 where preprocessing occurs. Preprocessing can include manufacturing steps which occur before braiding, including (but not limited to) application of adhesives, impregnation of non-fiber materials, stretch breaking of tows, et cetera. Preprocessing at 620 is shown in broken lines because preprocessing may not occur with manufacture of all braided structures. After preprocessing is complete at 620, methodology 600 proceeds to 630 where braiding occurs. At 630, at least one conductive tow and two or more nonconductive tows are braided together in a unit cell, and the unit cell repeated until the braided structure is complete. Optionally (as indicated by broken lines) thereafter, postprocessing can occur at 640, to include heating (for hot melting/shaping), gluing, cutting, et cetera. Once postprocessing (if any) is complete at 640, methodology 600 proceeds to 650 where the method ends.

Braiding in methodology 600 can occur in accordance with a predetermined total resistivity or resistivity per unit length of the braided structure. This predetermination can be made by using knowledge of the conductive tow material resistivity, which will then be factored in accordance with a constant based on its cross-sectional geometry (or a variable if the cross-sectional geometry varies over its length). If the fibers of the conductive tow are stretch-broken, a stretch-breaking constant can also be applied to the total number based on an average frequency and distance of discontinuity in the particular media consequent to stretch breaking. The total conductive tow length will also differ from the linear length of the braided structure, and so a length ratio can also be applied based on the unit cell geometry with consideration for lead angles, structure thickness, and any post-processing (e.g., twisting or other intentional deformation of the sleeve or planar structure). These considerations are not exhaustive but merely illustrative of the techniques employed to predetermine resistivity based on a particular processing and braiding procedure incorporating conductive tows.

While uniform resistivity is described above, other variants can also be provided. In an embodiment, the resistivity can vary throughout the structure. For example, a first portion of a structure can have a first resistivity (e.g., first one foot of linear structure length has a resistivity of 100 ohms per foot) and a second portion of a structure can have a second resistivity (e.g., adjacent one foot of linear structure length has resistivity of 180 ohms per foot).

While the above subject matter has been illustrated and described in detail in the drawings and foregoing discussion, the same is to be considered as illustrative and not restrictive in character, it being understood that example embodiments have been shown and described and that all changes and modifications that come within the scope and spirit of the invention are embraced by the disclosure.

What is claimed is:

1. A structure, comprising:
a plurality of nonconductive bias tows formed of fibers of a nonconductive material; and
at least one conductive tow formed of fibers including at least one conductive material,
the plurality of nonconductive bias tows and the at least one conductive tow are arranged to form a braided structure.

2. The structure of claim 1, the at least one conductive tow includes at least one bias tow.

3. The structure of claim 2, the at least one conductive tow includes at least one axial tow.

4. The structure of claim 1, the at least one conductive tow includes at least one axial tow.

5. The structure of claim 1, the at least one conductive tow includes two or more conductive tows defining two or more separate conductive paths.

6. The structure of claim 5, the two or more separate conductive paths are shielded from one another at least in part using a nonconductive portion of a braided structure.

7. The structure of claim 1, the at least one conductive tow is a stretch-broken conductive tow.

8. The structure of claim 1, at least a portion of the structure has a helical configuration.

9. The structure of claim 1, the structure is twisted such that the at least one conductive tow has a length longer than the linear length of the structure.

10. A structure, comprising:
a braided sleeve comprising at least a plurality of bias tows, the bias tows are formed of a non-conductive material; and
at least one axial tow, the at least one axial tow is formed of a conductive material,
the braided sleeve encloses the at least one axial tow.

11. The structure of claim 10, the braided sleeve has a non-circular cross section.

12. The structure of claim 11, the non-circular cross section of the braided sleeve is formed using a hot melt process.

13. A structure, comprising:
a non-conductive core formed of at least a plurality of nonconductive bias tows formed of fibers of a nonconductive material; and
at least one conductive tow helically wound around the non-conductive core according to a helical pattern including at least one lead angle.

14. The structure of claim 13, further comprising and adhesive in contact with at least a portion of the at least one conductive tow to maintain the helical pattern.

15. The structure of claim 13, at least a portion of the at least one conductive tow is heat treated to maintain the helical pattern.

16. The structure of claim 13, the at least one conductive tow is stretch-broken.

17. A method, comprising
providing a plurality of non-conductive tows;
providing at least one conductive tow;
braiding the non-conductive tows and at least one conductive tow to form a unit cell pattern, the non-conductive tows comprise at least bias tows;
repeatedly braiding the unit cell pattern to produce a braided structure.

18. The method of claim 17, further comprising:
forming the braided structure to a non-circular cross-sectional shape; and
heating the braided structure to perform a hot melt process on the non-circular cross-sectional shape.

19. The method of claim 17, further comprising pulling the at least one conductive tow using rollers at a rate faster than the at least one conductive tow is being fed to complete a stretch-breaking process on the at least one conductive tow.

20. The method of claim 17, further comprising twisting the braided structure.

21. The method of claim 17, the braiding of at least the non-conductive tows occurs around a conductive core.

22. The method of claim 17, further comprising:
arranging the at least one conductive tow in accordance with a lead angle; and
adhering at least the at least one conductive tow to fix the at least one conductive tow into the lead angle.

23. The method of claim 17, further comprising impregnating at least one tow with an adherent before braiding.

24. The method of claim 17, further comprising applying a protective cover to at least one of the at least one conductive tow and the plurality of non-conductive tows.
